(19) United States
(12) Patent Application Publication
(10) Pub. No.: US 2009/0118396 A1
(43) Pub. Date: May 7, 2009

(54) PROCESS TO MANUFACTURE WOOD FLOUR AND NATURAL FIBERS TO ENHANCE CELLULOSIC PLASTIC COMPOSITES

(75) Inventors: Stephen J. Faehner, Silver Springs, MD (US); Michael J. Pisczor, Weston, WI (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: AMERICAN WOOD FIBERS, Columbia, MD (US)

(21) Appl. No.: 11/933,832

(22) Filed: Nov. 1, 2007

(51) Int. Cl. C08L 97/02; C08J 3/00

(52) U.S. Cl. 524/13

(57) ABSTRACT

A process for combining wood flour with one or more natural fibers into a mixture subsequently used in making NFPC thermoplastic and thermoset composites. The process involves blending the wood flour and natural fibers with the resulting mixture containing from between 5%-95% natural fibers. After blending, the resultant mixture goes through one or more stages in which particles in one range of sizes are separated out from particles having a different range of sizes. The separated mixture is packaged and the contents subsequently being used in making the NFPC composites by mixing thermoplastics or thermoset materials with upwards of 50% of the wood flour and natural fiber material blend.

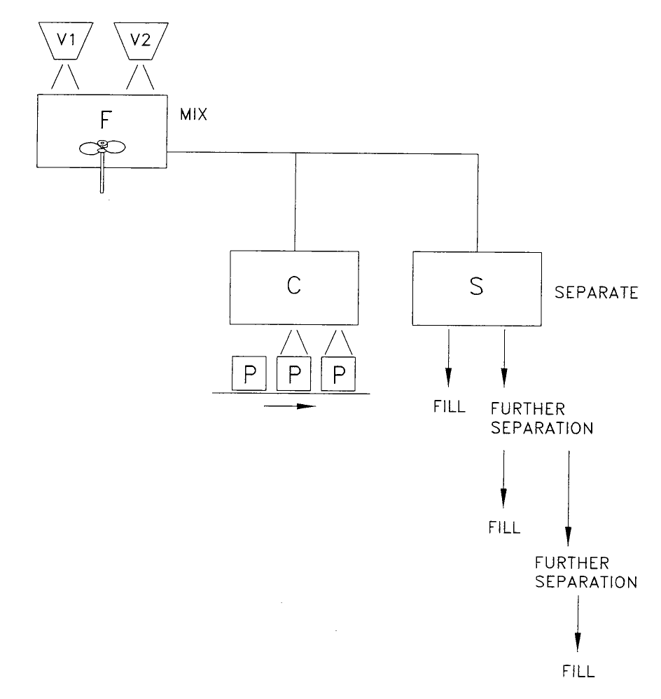

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention generally relates to wood replacement materials such as a natural fiber plastic composite (NFPC); and more particularly, to a process for manufacturing and blending wood flour and natural fibers for extending and enhancing filled cellulosic thermoplastic and thermoset composites.

Wood flour is used as a filler material in plastic products employed in the construction industry. It includes, for example, saw dust and wood chips which are created during the processing of trees. Synthetic wood materials such as cellulosic reinforced plastic composite materials, which are comprised in part of a wood flour, are being increasingly used in the construction and other industries.

There are several reasons for this. A primary reason is the increasing cost of wood for use in these industries. For another, domestic production of wood products has declined significantly resulting in a reduction in wood by-products necessary to producing wood flour. Further, the wood products industry has improved their yield capability, thereby reducing the amount of wood by-products even further. Also, the offshore manufacture of wood products which are shipped into the U.S. has had a profound effect on the availability of wood by-products which are available to be utilized in the manufacture of wood flour since these by-products (the sawdust and wood chips) are not exported to the U.S.

The result has been not only an increasing demand for alternatives to solid wood to be used in products for these industries, but a better way of utilizing the wood by-products available for making NFPC synthetic wood materials such as cellulosic reinforced plastic composite materials, which are now commonly used. However, because of the several factors noted above, a significant strain has developed in obtaining the wood flour ingredients traditionally used in making the NFPC. Several attempts have been made to find other materials which could extend wood flour materials in NEPC; but, those attempts have largely failed due to the resulting poor quality of the resultant NFPC when used in real world applications. The present invention overcomes those past failures to provide a high quality cellulosic reinforced plastic composite material for use in a wide range of applications.

### BRIEF SUMMARY OF THE INVENTION

The present invention is directed to a process for combining wood flour and one or more natural fibers into a mixture used in making NFPC thermoplastic and thermoset composites. The process involves combining wood flour and natural fibers together, and then separating out the resultant mixture, by particle size. Mixtures of different particle sizes are then used in making different NFPC composite materials. The mixture may contain from between 5%-95% of natural fibers.

The resulting mixture combines advantageous attributes of both the wood flour and the natural fibers used. These include such characteristics as weight, flowability, and material handling characteristics of the combined wood flour and natural fiber materials. They also include increased process throughputs, better thermal dynamics, and higher strength properties of the resulting NFPC in which the mixture is used.

Other objects and features will be in part apparent and in part pointed out hereinafter.

### BRIEF DESCRIPTION OF THE SEVERAL VIEWS OF THE DRAWINGS

The sole FIGURE of the drawings illustrates the manufacturing process for blending together wood flour and natural fibers.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

In accordance with the present invention, wood flour and one or more natural fibers are loaded from respective vats V1, V2 into a feed vessel F of a sufficient size as to allow blending of the materials to begin. As noted above, the wood flour is comprised of, among other ingredients, sawdust and wood chips. While the sawdust is a granular material of small particle size, the size of the wood chips may vary. The natural fibers incorporated into the mixture include one or more of the following: alfalfa, bagasse, bamboo, coconut husks, corn stalks, cotton, cotton gin waste, flax, hemp, kenaf, oat hulls, peanut hulls, rice hulls, sisal, switch grasses wheat stalks, or other types of cellulosic materials. The particle size of the natural fibers added to the mixture will also vary. The amount of the natural fibers used in the mixture ranges between 5%-95%, by weight.

The mixing of the ingredients is accomplished in any of a number of ways known to those skilled in the art. The resulting mixture is then conveyed from feed vessel F to a station where there is located a container C for packaging in packages P. The packaged mixture is now shipped to a NFPC manufacturer for use in producing cellulosic thermoplastic and thermoset composites.

Alternately, from feed vessel F, the mixture can be transported to another station where there is located a separator S, or other size reduction equipment, for filtering or classification of the mixture, by particle size of the mixture's contents. This is done so that the particle sizes of contents with which the packages are filled are relatively homogeneous. Separator S, for example, filters the particles comprising the mixture into multiple ranges of particle sizes; with, for example, particles falling in a first range of sizes being deposited in a first container (not shown), and particles falling into a second and separate range of sizes being deposited in a second container (also not shown). It will be appreciated by those skilled in the art that the mixture can be separated into more than two ranges of particle sizes.

From this station, the respective containers are taken to a station where their contents are off-loaded into containers used to fill packages with the respectively sized mixtures. Or, one or more of the containers are conveyed to secondary separation station where their contents are processed through a second separator which further filters the particles comprising the mixture into even smaller sizes, so to make the mixture with which packages are filled even more homogeneous. If desired, a tertiary separation or size reduction process can be employed to achieve yet a higher degree of homogeneity in the contents of a package. This is as shown in the drawing FIGURE.

With respect to the above described process, at least 90% of the particles comprising the wood flour mixture should pass through a 5 mesh (4000 micron) screen, with preferably less than 80% of the particles passing through a 325 mesh (45 micron) screen. Preferably, the 90% of the particles should pass through a 20 mesh (850 micron) screen and a 100 mesh (150 micron) screen.

The moisture content of the particles is between 45%-1%, with the lesser moisture content being preferable. Bulk density of the particles should range from 4-50 lbs/ft³ with a preferred range of 15-25 lbs/ft³.

The resulting mixture produced in accordance with the process of the present invention is useful in many different manufacturing processes including extrusion, pulltrusion, injection molding, open molding, ram extrusion, and compression molding. Blends of wood flour and natural fibers containing 5%-95% natural fibers, when mixed with wood flour, show benefits to the processes indicated above that normally utilize only non-blended natural fibers. In these manufacturing environments, either thermoplastics or thermoset materials are combined with upwards of 65%, by volume, of the wood flour and natural fiber material blend. Other process aides are used to improve the processability including certain resins, lubricants such as wax, or other compatibilizers, inhibitors, enhancers and cross linking agents.

In view of the above, it will be seen that the several objects and advantages of the present disclosure have been achieved and other advantageous results have been obtained.

1. A process for making NFPC thermoplastic and thermoset composites comprising:
blending wood flour and one or more natural fibers into a mixture; and,
mixing thermoplastics or thermoset materials with the wood flour and natural fiber material blend.

2. The process of claim 1 in which the thermoplastics or thermoset materials are mixed with up to 65%, by volume or weight, of the wood flour and natural fiber material blend.

3. The process of claim 1 further including separating out the resultant mixture, by particle size.

4. The process of claim 3 further including a second separating step for further separating the resultant mixture by particle size.

5. The process of claim 4 further including a third separating step for still further separating the resultant mixture by particle size.

6. The process of claim 1 in which the natural fibers blended with the wood flour include one or more of the following: alfalfa, bagasse, bamboo, coconut husks, corn stalks, cotton, cotton gin waste, flax, hemp, kenaf, oat hulls, peanut hulls, rice hulls, sisal, switch grasses, wheat stalks, or other types of cellulosic materials.

7. The process of claim 6 in which the natural fibers comprise between 5%-95%, by weight, of the mixture.

8. The process of claim 1 in which the NFPC further includes other process aides used to improve processability.

9. The process of claim 8 in which the processability aides include one or more of resins, lubricants including wax, compatibilizers, inhibitors, enhancers and cross linking agents.

10. A process for making NFPC thermoplastic and thermoset composites comprising:
blending wood flour and one or more natural fibers into a mixture;
separating out the resultant mixture by particle size; and,
mixing thermoplastics or thermoset materials with the wood flour and natural fiber blend, the thermoplastics or thermoset materials being mixed with up to 65%, by volume, of the wood flour and natural fiber material blend.

11. The process of claim 10 in which the natural fibers comprise between 5%-95%, by weight, of the mixture.

12. The process of claim 11 in which the natural fibers blended with the wood flour include one or more of the following: alfalfa, bagasse, bamboo, coconut husks, corn stalks, cotton, cotton gin waste, flax, hemp, kenaf, oat hulls, peanut hulls, rice hulls, sisal, switch grasses, wheat stalks, or other types of cellulosic materials.

13. The process of claim 10 further including a second separating step for further separating the resultant mixture by particle size.

14. The process of claim 13 further including a third separating step for still further separating the resultant mixture by particle size.

15. A NFPC thermoplastic or thermoset composite comprising:
wood flour and one or more natural fibers blended into a into a mixture containing between 5%-95% natural fibers; and,
thermoplastics or thermoset materials mixed with the wood flour and natural fiber material blend, the thermoplastics or thermoset materials being mixed with up to 50%, by volume, of the wood flour and natural fiber material blend.

16. The NFPC thermoplastic or thermoset composite of claim 15 in which at least 90% of the particles comprising the wood flour mixture pass through a 5 mesh (4000 micron) screen, with preferably less than 80% of the particles passing through a 325 mesh (45 micron) screen.

17. The NFPC thermoplastic or thermoset composite of claim 16 in which, preferably, 90% of the particles pass through a 20 mesh (850 micron) screen and a 100 mesh (150 micron) screen.

18. The NFPC thermoplastic or thermoset composite of claim 15 in which the moisture content of the particles ranges between 45%-1%, with the lesser moisture content being preferable

19. The NFPC thermoplastic or thermoset composite of claim 15 in which the bulk density of the particles ranges between 4-50 lbs/ft³.

20. The NFPC thermoplastic or thermoset composite of claim 19 in which the bulk density of the particles ranges preferably ranges between 15-25 lbs/ft³
